(19) United States
(12) Patent Application Publication
(10) Pub. No.: US 2013/0220943 A1
(43) Pub. Date: Aug. 29, 2013

(54) Method for treating untreated salt water for producing treated water, thus produced treated water and device for carrying out said method

(71) Applicants: Rainer Huss, Buchenberg (DE); Rene Wodrich, Greifswald (DE); Ulrich Plantikow, Munich (DE)

(72) Inventors: Rainer Huss, Buchenberg (DE); Rene Wodrich, Greifswald (DE); Ulrich Plantikow, Munich (DE)

(73) Assignee: WME Gesellschaft für windkraftbetriebene Meerwasserentsalzung mbH, Starrvitz, Draske/Rugen (DE)

(21) Appl. No.: 13/805,435

(22) PCT Filed: Aug. 27, 2010
(86) PCT No.: PCT/EP10/05285

§ 371 Date: May 9, 2013

(30) Foreign Application Priority Data
Jun. 21, 2010 (DE) 102010017490.4

(51) Int. Cl. C02F 1/72

(52) U.S. Cl. CPC C02F 1/72
USPC 210/748.17; 210/758; 210/198.1

(57) ABSTRACT

The present invention relates to a method of treating an untreated saline water (RW), a process water (PW) thereby produced, and a device for carrying out said method. The method includes the steps of: a) furnishing the untreated water (RW); b) producing a mixture (M) by mixing the untreated saline water (RW) with an aqueous solution (HL) containing hydroxide ions; c) sedimenting the solid (FS) forming from the mixture (M) with concurrent formation of an essentially clear supernatant (U); and d) withdrawing process water (PW) from the essentially clear supernatant (U).

### CROSS-REFERENCE TO RELATED APPLICATION

This is a U.S. national stage application under 35 U.S.C. §371 of International Patent Application No. PCT/EP2010/005285, filed Aug. 27, 2010, and published as WO 2011/160663 on Dec. 29, 2011, which claims the benefit of German Patent Application No. 10 2010 017 490.4, filed Jun. 21, 2010, both of which are incorporated by reference herein. This application is related to U.S. patent application Ser. No. 13/805,434, which is a U.S. national stage application under 35 U.S.C. §371 of International Patent Application No. PCT/EP2010/005284, filed Aug. 27, 2010, and published as WO 2011/160662, on Dec. 29, 2011, which claims the benefit of German Patent Application No. 10 2010 017 491.2, filed Jun. 21, 2010.

### BACKGROUND OF THE INVENTION

Natural salt waters such as, e.g., sea water, comparable saline subsurface waters, waters presenting even higher salt concentrations such as, e.g., sea water concentrate, natural or synthetically produced brines having a salt content of at least 0.4 to more than 20% (wt.) are employed for a number of applications:

In the production of drinking water by means of sea water desalination they serve as a starting material or untreated water having a usual salt content in the range from approx. 1 to 5% (wt.).

These natural salt waters furthermore serve as a source for obtaining crystalline salt for the chemical industry, food production, water treatment such as, e.g., use as an ion exchanger salt, de-icing salt, and the like.

Natural salt waters are moreover being used as curative brine in the wellness field and in the medical application of waters, where they frequently have a very high salt concentration.

In most of the applications named in the foregoing, natural salt waters include substances which may lead to the formation of water-insoluble crusts during the application. In particular during processing in the corresponding devices, alkaline earth metal ions such as, e.g., Mg²⁺, Ca²⁺, Sr²⁺ and Ba²⁺ may precipitate in the form of a poorly soluble crust upon a temperature increase, above all in conjunction with reduced pressure, owing to the release of CO₂ from the saline solution:

Mg(HCO₃)₂→Mg(OH)_{2↓}+2CO_{2↑}

Ca(HCO₃)₂→CaCO_{3↓}+CO_{2↑}++H₂O

Sr(HCO₃)₂→SrCO_{3↓}+CO_{2↑}++H₂O

Ba(HCO₃)₂→BaCO_{3↓}+CO_{2↑}++H₂O

Such a crust is hard and mostly adheres strongly to the underground, whereby a subsequent mechanical removal is rendered difficult.

Apart from the incrustations, an interference is caused in many applications by undissolved, fine, partly suspended particles such as, e.g., sand or algae, as well as dissolved organic substances such as, e.g., fish mucilage, constituents of mineral oil, fuel, and bilge water, as well as residues of unpurified or insufficiently purified effluent.

Thus, from document DE 102 178 85 A1—the contents of which are hereby fully incorporated by way of reference—there is known a method for electrochemical conditioning of a medium such as sea water or the like for its desalination, wherein the interfering incrustations and deposits described in the foregoing are avoided at least to a large degree by pre-conditioning of the corresponding untreated water such as, e.g., sea water.

In a sea water desalination plant or the like it is hereby made possible in an electrochemical way, without external addition of an acid, to keep the pH in the concentrate constant or lower it during concentration by evaporation.

Certain kinds of impurities in the salt water such as, e.g., alkaline earth metal ions as well as dissolved or undissolved extraneous matter may, however, result in an impairment of the electrochemical reaction.

### BRIEF SUMMARY OF THE INVENTION

It is therefore an object of the present invention to provide a method by means of which alkaline earth metal ions as well as dissolved or undissolved extraneous matter, in particular particles and organic substances, may in a simple and effective manner be removed at least to a large degree from an untreated saline water to be treated.

It is one aspect of the present invention to provide a process water that may be used as a catholyte in an electrodialysis process without further treatment.

It is another aspect of the present invention to provide a device for carrying out the method of the invention.

The above object and/or aspects are achieved through a method described herein of treating an untreated saline water, a process water described herein produced by the method described herein, and a device described herein for carrying out the method described herein.

The method of treating an untreated saline water (RW) includes the steps of:
a) furnishing the untreated saline water (RW);
b) producing a mixture (M) by mixing the untreated saline water (RW) with an aqueous solution (HL) containing hydroxide ions;
c) sedimenting the solid matter (FS) forming from the mixture (M) with concurrent formation of a substantially clear supernatant (U); and
d) withdrawing a process water (PW) from the substantially clear supernatant (U).

The process water is produced with at least the above method.

The device for carrying out at least the above method comprises at least:
a) a reaction vessel, preferably for carrying out at least one of steps (a) to (d);
b) a storage vessel, preferably for storing the aqueous solution (HL) containing hydroxide ions;
   characterized in that the reaction vessel comprises a flow introduction means for tangential flow introduction of the untreated saline water (RW) and/or the aqueous solution (HL) containing hydroxide ions.

What is for the first time being proposed in accordance with the invention is a method of treating an untreated saline water, including the steps of:
a) furnishing the untreated saline water;
b) producing a mixture by mixing the untreated saline water with an aqueous solution containing hydroxide ions;
c) sedimenting the solid matter forming from the mixture with concurrent formation of a substantially clear supernatant; and
d) withdrawing a process water from the substantially clear supernatant.

What is thus being proposed for the first time in accordance with the invention is a method wherein a solution containing hydroxide ions is added to an untreated saline water, whereby the alkaline earth metal ions dissolved in the untreated saline water may be precipitated in the mixture as poorly soluble hydroxides or carbonates having the form of an insoluble solid matter, to thus be separated from the liquid phase.

By way of example, the following reactions are employed for the purpose of precipitating the alkaline earth metal ions:

MgCl₂+2NaOH→Mg(OH)_{2↓}+2NaCl

CaCl₂+CO₂+2NaOH→CaCO_{3↓}+2NaCl

SrCl₂+CO₂+2NaOH→SrCO₃↓+2NaCl

BaCl₂+CO₂+2NaOH→BaCO₃↓+2NaCl

In accordance with the invention, an aqueous solution containing hydroxide ions is understood to be a water-based liquid which contains hydroxide ions. This includes any aqueous solutions containing hydroxide in a dissolved form, but also any suitable suspensions and emulsions including hydroxide ions.

Here it is of particular advantage that the precipitation products named in the foregoing and produced by means of the method of the invention, namely, alkaline earth metal hydroxides and carbonates, at the same time serve as precipitation agents for jointly also precipitating other undesirable extraneous matter, such as particles or dissolved organic substances, from the employed untreated water. In the process, the undesirable extraneous matter is enclosed in the clots forming during precipitation of the solid matter.

The clot-type solid matter having formed in the above-described manner settles out with concurrent formation of a clear supernatant. Finally, by withdrawing the substantially clear supernatant, a ready-for-use process water is obtained which is suited, e.g., for its use as a catholyte in an electrodialysis process because of its high concentration of chloride ions.

In accordance with the invention, withdrawing the process water is understood as separating or recovering the process water from the clear supernatant of the mixture which substantially does not contain any solid matter.

Advantageous developments of the treatment method in accordance with the invention are subject matter of additional appended claims.

Thus, the untreated saline water may be a natural or synthetically produced salt water, preferably a sea water, a brackish water, a subsurface water, a spring water, a natural or synthetically produced brine, or mixtures or concentrates thereof.

Virtually any naturally occurring or synthetically produced saline waters may thus be employed as untreated water for the method according to the invention. Accordingly, the method according to the invention employs a substantially ubiquitous starting material, resulting in a wide geographical area of use. Such saline bodies of water are available virtually anywhere and at a low cost.

The untreated saline water may moreover present a salt content, in particular a content of alkali metal salts up to saturation, preferably in the range from 0.4 to 25% (wt.), in a more preferred manner 2 to 10% (wt.), in particular 2.8 to 4.6% (wt.).

Hereby it is advantageously made possible to utilize waters having a high salt content such as, e.g., industrial waste waters having a high salt content, sea water concentrates, or for example natural sea waters having high salt concentrations such as, e.g., water from the Dead Sea, in the framework of the method of the invention. On the other hand, sea water having an average salt content may also readily be employed as an untreated water in the method of the invention.

The aqueous solution containing hydroxide ions may furthermore be produced from the process water obtained in step (d).

In accordance with the invention, this provides the possibility of reusing the process water in the sense of a recycling process after its utilization in an electrochemical method as an aqueous solution containing hydroxide ions.

Advantageously this serves to lower the process cost and minimize the quantities of starting and waste materials, whereby the environmental compatibility of the method of the invention is improved considerably.

In particular the aqueous solution containing hydroxide ions may be produced by means of an electrodialysis process.

In accordance with the present method as described in the foregoing, the solutions containing hydroxide ions which are engendered in the form of a waste product in an electrodialysis process, are advantageously used as a precipitating agent. From the viewpoint of the electrodialysis process, this has on the one hand the effect of solving the problem of disposal of the effluents containing hydroxide ions, whereas on the other hand a source of starting material is furnished for the method according to the invention.

In addition, the aqueous solution containing hydroxide ions may have a carbon dioxide content up to saturation, preferably in the range from 0.5 to 5 g/l, in particular 1 to 3 g/l.

Hereby the precipitation of the alkaline earth metal ions present in the form of carbonates, as was described in the foregoing, is advantageously improved.

The carbon dioxide may originate from some other process such as, e.g., from a thermal sea water desalination process. Alternatively the carbon dioxide may also be extracted from air by trickling processing of the solution containing hydroxide ions, for instance in an absorption scrubbing tower.

In a particularly preferred manner, the excess of carbon dioxide in the aqueous solution containing hydroxide ions in terms of the above-described precipitation reactions preferably is between 30 and 100%.

In accordance with the invention, the mixture may have a pH in the range from 11 to 14, preferably in the range from 12 to 14, in particular ≧13.

As the result of an excess of hydroxide ions in an amount of preferably between 30 and 100% in the aqueous solution containing hydroxide ions, a substantially quantitative precipitation of the alkaline earth metal ions from the mixture is brought about. This advantageously allows to obtain a process water substantially free of alkaline earth metal ions as a product of the method of the invention. Consequently the produced process water may be employed directly as a catholyte in the framework of an electrodialysis process. This allows to practically exclude a damaging effect on membranes due to alkaline earth metal ions in the electrolyte.

An excess of carbon dioxide and/or hydroxide ions moreover presents the advantage that a substantially quantitative precipitation may be ensured even with a highly varying quality of untreated waters.

In addition, in step (b) the said mixture may be produced by flow introduction of the aqueous solution containing hydroxide ions into the untreated saline water.

This allows to simplify the implementation of the method in terms of plant technology due to smaller storage vessels for the aqueous solution containing hydroxide ions.

Furthermore, in step (b) the flow introduction of the aqueous solution containing hydroxide ions into the untreated saline water that was charged into a reaction vessel may substantially take place in a tangential direction, wherein the reaction vessel preferably has a substantially cylindrical or cylindro-conical shape.

Moreover, in step (b) the flow introduction of the untreated saline water into the aqueous solution containing hydroxide ions that was charged into the reaction vessel may substantially take place in a tangential direction, wherein the reaction vessel preferably has a substantially cylindrical or cylindro-conical shape.

Due to the tangential flow introduction, intense mixing of the untreated water with the aqueous solution containing hydroxide ions and homogenization of the resulting mixture are achieved.

Moreover only a low shearing stress takes place during mixing, so that a destruction of the clot-type solid matter forming in the precipitation reaction is largely avoided.

Furthermore, the entire liquid body is caused to perform a rotational movement, so that it is advantageously possible to omit an additional stirring mechanism or other devices such as, e.g., baffles.

In step (b) the inflow velocity of the untreated saline water and/or the aqueous solution containing hydroxide ions may be situated in the range from 0.1 to 10 m/s, preferably 1 to 3 m/s, in particular 2 to 2.5 m/s.

This achieves not only optimum intermixing but also rapid settling of the forming clot-type solid matters.

Furthermore the formation of unstable and finely dispersed, suspended particles having a low settling tendency is avoided.

The method may further include the step of:
e) after step (b), application of carbon dioxide to the mixture.

As a result of the presence of carbon dioxide in the aqueous solution containing hydroxide ions, the precipitation process is favored advantageously, particularly with regard to the alkaline earth metal ions Ca²⁺, Sr²⁺, and Ba²⁺. Namely, this serves to facilitate the quantitative precipitation of the above-mentioned ions in the form of their carbonates and thus their removal from the process water.

In addition, the method according to the invention may further comprise the step of:
f) after step (d), adjusting the pH of the process water to a predetermined value.

Moreover the method may further include the step of:
g) after step (d), application of carbon dioxide to the process water.

In addition the method may further include the step of:
h) after step (d), application of hydrochloric acid to the process water.

Due to conditioning of the produced process water by the application of carbon dioxide, hydrochloric acid and/or adjusting the pH, the process water may advantageously be adjusted to the optimum conditions for its further utilization, for instance in an electrodialysis process.

Furthermore the method may further include the step of:
i) after one of steps (d), (f), (g) or (h), omitting an addition of further substances to the process water.

The process water obtained by means of the method of the invention may be used without the addition of further substances. This not only avoids the use of further auxiliary agents such as, e.g., chemicals, in a cost-efficient manner, but a further mixing and/or homogenization step which would in turn necessitate corresponding preconditions in terms of installation technology is also avoided.

Furthermore the method may include the step of:
j) after step (d), carrying off the sedimented solid matter.

The liquid sludge furthermore brought about by sedimenting the solid matter having formed from the mixture may be extracted separately and disposed of as waste matter. Alternatively this liquid sludge may also be employed as a useful material in case the untreated water employed for its production presented a comparatively high degree of purity (so-called blue water).

Namely, where the liquid sludge does not contain organic substances or only a small amount thereof, it may be employed for hardening demineralized water as is incurred, e.g., in a sea water desalination plant. To this end the solid matter suspension of the liquid sludge is washed to remove salt and dissolved with an addition of CO₂ in the demineralized water.

The sludge particles having been freshly precipitated are very small and have a large internal surface, for which reason they dissolve completely, for example in demineralized water, within a few minutes. Such lime conditioning may advantageously take place in an in-line system having a very small structural design.

In addition, in step (b) the volume-related mixing ratio of the untreated saline water to the aqueous solution containing hydroxide ions may be in the range between 50 to 90 and 50 to 10, preferably between 55 to 70 and 45 to 30, in particular 60 to 40.

Thanks to this mixing ratio it possible to achieve a substantially quantitative precipitation of the alkaline earth metal ions; namely, the pH of the engendered mixture is here situated in a highly alkaline range, preferably in a range from 12 to 14. As a result the concentration of the hydroxide ions in the resulting mixture is sufficiently high to obtain virtually quantitative precipitation of the alkaline earth metal ions of the untreated water.

In step (c) the solid matter may be sedimented for a duration until the entirety of the solid matter substantially is within a volume amounting to no more than 60, preferably no more than 40, in particular no more than 25% of the total volume of the mixture.

This high concentration consequently allows to produce a large volume of process water within a short time period, whereby the efficiency of the method of the invention is enhanced.

As regards the product, the object according to the invention is achieved through the process water that was produced with the method in accordance with the invention.

Namely, what is being claimed in accordance with the invention is a process water that was produced with the method in accordance with the invention.

Advantageous developments of the process water of the invention include: the process water described herein, characterized in that the process water (PW) is substantially free of dissolved alkaline earth metal ions, in particular Mg2+, Ca2+, Sr2+, and Ba2+; and

the process water described herein, characterized in that the process water (PW) is substantially free of extraneous matter, in particular particles and/or organic substances.

Thus, the water may be substantially free of dissolved alkaline earth metal ions, in particular Mg²⁺, Ca²⁺, Sr²⁺, and Ba²⁺.

As it is known that the earth alkali ions mentioned in the foregoing have a damaging effect on electrodialysis membranes, the process water according to the invention is suited for being used as a catholyte in an electrodialysis process.

Moreover the process water may be substantially free of extraneous matter, in particular particles and/or organic substances.

Hereby a contamination of plant parts during the further use of the process water, in particular in the form of a catholyte for an electrodialysis process, is avoided to a large degree. Further cleaning dispositions, which are cost-intense and complex in terms of plant technology, are moreover not required.

In terms of device technology, the object of the invention is achieved through the device described herein.

Thus, what is being proposed is a device for carrying out a method, comprising at least:
a reaction vessel, preferably for carrying out at least of one of steps (a) to (d);
a storage vessel, preferably for storing the aqueous solution containing hydroxide ions.

The said reaction vessel comprises a flow introduction means for tangential flow introduction of the untreated saline water and/or the aqueous solution containing hydroxide ions.

Tangential flow introduction in the area of a cylindrical section of the reaction vessel allows to homogenize the mixture in accordance with the invention and/or cause it to perform a rotating movement in the most simple manner and at the lowest expenditure of energy.

Advantageous developments of the device in accordance with the invention are subject matter of additional appended claims. The advantages of the method of the invention apply analogously.

Thus, the flow introduction means may be disposed in the area of a wall, preferably a side wall, of the reaction vessel.

Moreover the reaction vessel may have a substantially cylindrical or cylindro-conical shape.

Furthermore the reaction vessel may include an outlet opening in the lower wall area of the reaction vessel.

Hereby the engendered solid matter or liquid sludge may be removed from the reaction vessel in a simple manner and separately from the process water.

It is particularly advantageous if the reaction vessel does not comprise any further mechanical homogenizing means, in particular no stirrer or baffle.

Hereby the complexity in terms of plant technology as well as the cleaning expenditure for the device are minimized.

Lastly, the storage vessel may have a volume capacity of at least 20%, preferably about 30 to 80%, in particular about 75%, of the reaction vessel.

### BRIEF DESCRIPTION OF THE DRAWINGS

The invention is explained in more detail through the following practical examples while making reference to the figures of the drawings, wherein:

FIG. 1 is a schematic overview of an electrodialysis system employing the treatment method in accordance with the invention as well as the associated device;

FIG. 2 is a schematic representation of a device for carrying out the treatment method in accordance with the invention.

### DETAILED DESCRIPTION

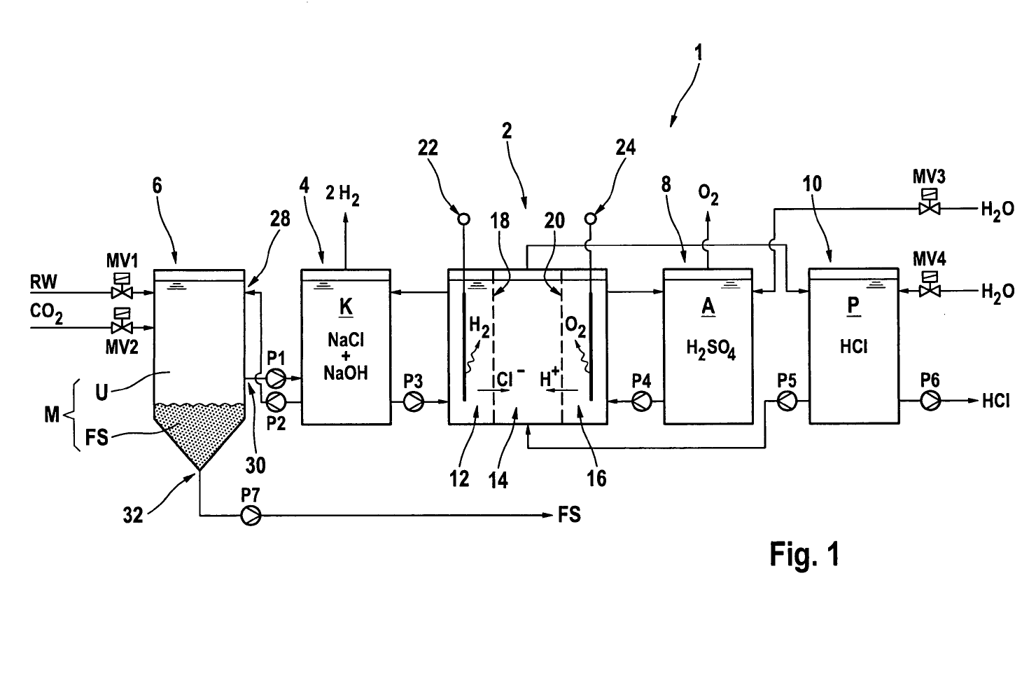

The electrodialysis system 1 represented in FIG. 1 comprises an electrodialysis cell 2, a storage vessel 4 for a catholyte K, a reaction vessel 6, a storage vessel 8 for an anolyte A, as well as a storage vessel 10 for a product P.

The electrodialysis cell 2 comprises a cathode space 12, a product space 14, and an anode space 16. The cathode space 12 is separated from the product space 14 by an anion exchanger membrane 18. The anode space 16 is separated from the product space 14 by a cation exchanger membrane 20. Inside the cathode space 12 a cathode 22 is arranged which is surrounded by the catholyte K. Analogously, inside the anode space 16 an anode 24 is arranged which is surrounded by the anolyte A.

The storage vessel 4 for the catholyte K has any desired, preferably cylindrical, shape. The reaction vessel 6 has a cylindrical, preferably cylindro-conical, shape. The storage vessel 8 for the anolyte A as well as the storage vessel 10 for the product may have any desired shape.

Furthermore the electrodialysis system 1 comprises conduits of pipes, pumps, valves and the like, presently not described in more detail, whereby the individual vessels such as, e.g., the electrodialysis cell 2, the storage vessel 4, the reaction vessel 6, the storage vessel 8, and the storage vessel 10 are connected to each other and whereby starting materials, intermediate products and final products may be transported within the electrodialysis system 1.

In the anode space 16 of the electrodialysis cell 2 the following anode reaction takes place:

2H₂O→4H⁺+O_{2↑}+4e⁻

According to this reaction the anolyte A loses water while protons and gaseous oxygen are released at the anode. The anolyte A includes sulfuric acid which serves to improve conductivity but is not reacted during the anode reaction.

In the cathode space 20 the so-called cathode reaction takes place:

2NaCl+2H₂O+2e⁻→2NaOH+2Cl⁻+H_{2↑}

As a result of the ion migration through the membrane, the concentration of chloride ions in the catholyte K diminishes. In contrast, the concentration of hydroxide ions increases. Gaseous hydrogen is furthermore released at the cathode 22.

Chloride ions migrate from the cathode space 12 through the anion exchanger membrane 18. In contrast, protons migrate from the anode space 16 through the cation exchanger membrane 20. In the product space 14 these two ion species combine to form the desired product hydrogen chloride HCl or an aqueous solution thereof, namely, hydrochloric acid. The catholyte K contained in the cathode space 12 of the electrodialysis cell 2 is permanently circulated via the storage vessel 4 by means of a pump. Hereby it is possible to degas the catholyte K through discharge of hydrogen gas and at the same time enrich it with chloride ions by supplying chloride ions from outside into the storage vessel 4.

Finally, the catholyte K may be adjusted to a concentration of chloride ions that is optimal for the cathode reaction by circulating into the storage vessel 4.

On account of the anode reaction described in the foregoing, the anolyte A in the anode space 16 permanently loses water while gaseous oxygen is formed at the anode. By circulating the anolyte A into the storage vessel 8 the anolyte A may be degassed effectively by carrying off oxygen gas. Furthermore the concentration of anolyte A is diluted to the starting concentration prior to the reaction by supplying de-ionized water.

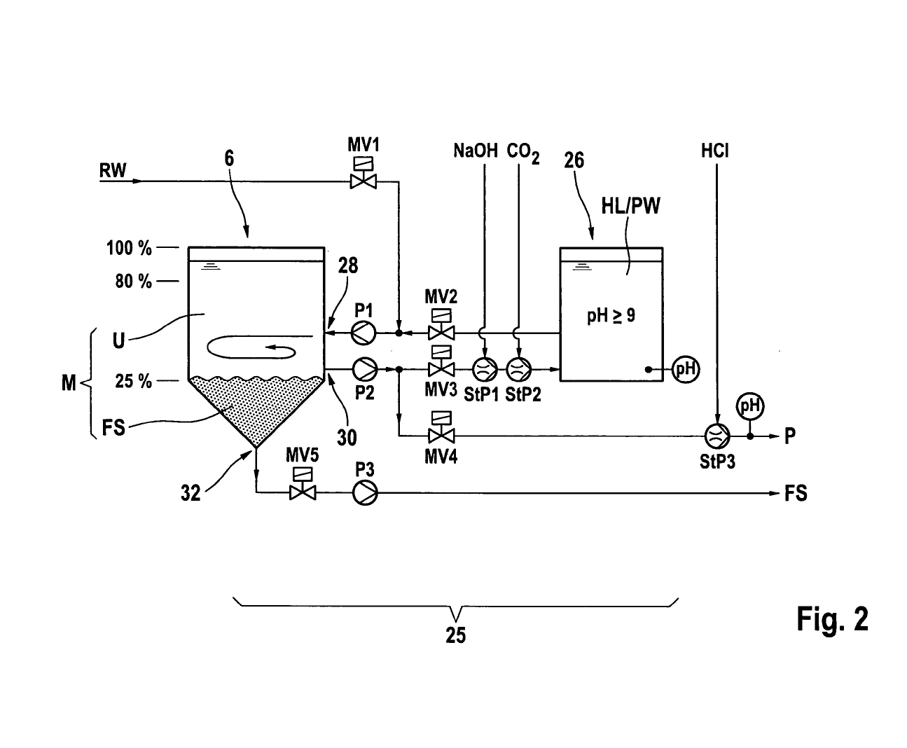

FIG. 2 shows a schematic representation of a device 25 in accordance with the invention, comprising a reaction vessel 6 and a storage vessel 26 for a process water PW. The reaction vessel 6 in accordance with the invention has a cylindro-conical shape. The reaction vessel 6 furthermore comprises a flow introduction means 28 in a cylindrical area of the reaction vessel 6, a flow removal means 30, as well as an outlet opening 32 in the cone of the reaction vessel 6.

The flow introduction means 28 allows the flow introduction of a liquid which is tangential to the circumference of the reaction vessel 6. The flow introduction means 28 is connected to the storage vessel 4 for the catholyte K via a conduit. Moreover the flow removal means 30 is connected to the storage vessel 4 for the catholyte K via a conduit.

Performing the treatment method in accordance with the invention starts out from a filled storage vessel 26, with the catholyte K contained therein being enriched in hydroxide ions and depleted in chloride ions due to the cathode reaction. The reaction vessel 6 is filled with untreated water RW, for example saline sea water, up to a volume capacity of 80%. Then the reaction vessel 6 is filled to 100% of the volume of the reaction vessel 6 with the aqueous solution HL containing hydroxide ions, which is the spent catholyte K. The aqueous solution HL containing hydroxide ions is introduced into the reaction vessel 6 via a flow introduction means 28, with the tangential inflow generating a circular flow of the volume of liquid present in the reaction vessel 6.

Owing to the precipitation reactions described in the foregoing, in particular the alkaline earth metal ions of the untreated water RW are reacted into their poorly soluble hydroxides by the excess of hydroxide ions from the solution HL containing hydroxide ions. Where the aqueous solution HL containing hydroxide ions further contains carbon dioxide, there also occurs a precipitation of poorly soluble alkaline earth metal carbonates.

The solid matters FS precipitating in the shape of clots are allowed to sediment in the reaction vessel 6 for such a duration until the precipitated solid matter FS is slightly below a lower sludge level of 10 to 40%, preferably 25%, of the total volume of the reaction vessel 6. A clear supernatant U may be withdrawn from the reaction vessel 6 in the form of purified or treated process water PW. About 60 to 90%, preferably about 75%, of the volume of the reaction vessel 6 is withdrawn as process water PW and introduced into the storage vessel 26.

By means of the jet pumps StP1 and StP2, caustic soda solution and/or carbon dioxide may be admixed to the process water PW in a respective defined quantity or in a pH-controlled manner.

The process water PW produced in this way may be employed as a starting material for sea water desalination. In particular, the process water PW which is rich in chloride ions and depleted in hydroxide ions may be used as fresh catholyte K for the cathode reaction. Where necessary, HCl may be admixed to the process water PW in a defined quantity or in a pH-controlled manner by means of the jet pump StP3.

The total withdrawn volume proportion of about 60 to 90%, preferably about 75%, of the reaction vessel 6 is employed as catholyte K for the cathode reaction.

The remaining volume proportion of about 10 to 40%, preferably about 25%, of the content of the reaction vessel 6 is withdrawn in the form of liquid sludge via the outlet opening 32 and discarded. Preferably, however, the solid matter FS suspended as liquid sludge is used for the hardening of distilled water if it contains only little or no organic substances. To this end it is washed to remove salt and dissolved, with an addition of carbon dioxide, in the demineralized water.

Inasmuch as freshly precipitated sludge particles are very small while having a very large internal surface, they dissolve completely within a few minutes. The lime conditioning may thus advantageously be carried out by means of a so-called in-line system having a very compact design.

In accordance with the invention, “salt” is understood to be any known salts, preferably alkali metal salts and/or alkaline earth metal salts, in a further preferred manner salts with halide ions as anion, in particular NaCl, or mixtures thereof.

Besides the practical examples explained in the foregoing, the invention allows for further design approaches.

Thus, the storage vessel 4 for the catholyte K may at the same time be used as a storage vessel for the process water PW. This advantageously allows to save a storage vessel.

In addition the flow introduction of the mixture M may take place tangentially into a substantially cylindrical or cylindro-conical reaction vessel 6.

In accordance with the invention, the reaction vessel 6 is not restricted to a substantially cylindrical or cylindro-conical shape. Thus the reaction vessel 6 may also have an elliptic or polygonal, in particular quadrangular to octagonal cross-sectional configuration. If the cross-sectional configuration of the reaction vessel 6 presents a plurality of corners, they may be rounded. The reaction vessel 6 may furthermore also have a substantially spherical shape.

As was set forth in the foregoing, the process water PW may advantageously be used for the production of hydrogen chloride or hydrochloric acid. Concerning further details in this regard, the contents of the patent application deposited at the same time by the same applicant and having the title: “Method for producing hydrogen chloride or an aqueous solution thereof by using an untreated saline water, product thereby produced, use of the product, and electrodialysis system” (German Patent Application No. 10 2010 017 491.2 DE, filed Jun. 21, 2010) are herewith fully incorporated by way of reference.

1. A method of treating an untreated saline water, the method comprising the steps of:
furnishing the untreated saline water;
producing a mixture by mixing the untreated saline water with an aqueous solution containing hydroxide ions;
sedimenting a solid matter forming from the mixture with concurrent formation of a substantially clear supernatant; and
withdrawing a process water from the substantially clear supernatant.

2. The method according to claim 1, wherein the untreated saline water comprises:
a natural salt water;
a synthetically produced salt water; or
a mixture of a natural salt water and a synthetically produced salt water.

3. The method according to claim 1, wherein the untreated saline water has a salt content up to saturation.

4. The method according to claim 1, wherein the aqueous solution containing hydroxide ions is produced from the process water.

5. The method according to claim 1, wherein the aqueous solution containing hydroxide ions is produced by an electrodialysis process.

6. The method according to claim 1, wherein the aqueous solution containing hydroxide ions has a carbon dioxide content up to saturation.

7. The method according to claim 1, wherein the mixture has a pH in the range from 11 to 14.

8-11. (canceled)

12. The method according to claim 1, further comprising the step of:
after the step of producing a mixture by mixing the untreated saline water with an aqueous solution containing hydroxide ions, applying carbon dioxide to the mixture.

13-17. (canceled)

18. The method according to claim 1, wherein, in the step of producing a mixture by mixing the untreated saline water with an aqueous solution containing hydroxide ions, a volume-related mixing ratio of the untreated saline water to the aqueous solution containing hydroxide ions is in the range between (50% of the untreated saline water/50% of the aqueous solution containing hydroxide ions) to (90% of the untreated saline water/10% of the aqueous solution containing hydroxide ions).

19. (canceled)

20. A process water produced according to a method comprising the steps of:
furnishing untreated saline water;
producing a mixture by mixing the untreated saline water with an aqueous solution containing hydroxide ions;
sedimenting a solid matter forming from the mixture with concurrent formation of a substantially clear supernatant; and
withdrawing the process water from the substantially clear supernatant.

21-28. (canceled)

29. A device for treating an untreated saline water, the device comprising:
a storage vessel configured to store an aqueous solution containing hydroxide ions; and
a reaction vessel configured to:
receive the untreated saline water;
receive the aqueous solution containing hydroxide ions;
produce a mixture by mixing the untreated saline water with the aqueous solution containing hydroxide ions;
sediment a solid matter forming from the mixture with concurrent formation of a substantially clear supernatant; and
withdraw a process water from the substantially clear supernatant;
wherein the reaction vessel is further configured to:
receive the untreated saline water by substantially tangential flow;
receive the aqueous solution containing hydroxide ions by substantially tangential flow; or
receive the untreated saline water by substantially tangential flow and receive the aqueous solution containing hydroxide ions by substantially tangential flow.

30. The method according to claim 1, wherein the step of producing a mixture by mixing the untreated saline water with an aqueous solution containing hydroxide ions comprises the step of:
producing the mixture by flow introduction of the aqueous solution containing hydroxide ions into the untreated saline water.

31. The method according to claim 30, wherein the step of producing the mixture by flow introduction of the aqueous solution containing hydroxide ions into the untreated saline water comprises the steps of:
charging a reaction vessel with the untreated saline water; and
introducing the aqueous solution containing hydroxide ions into the untreated saline water via a substantially tangential flow.

32. The method according to claim 30, wherein the aqueous solution containing hydroxide ions has an inflow velocity in the range from 0.1 m/s to 10 m/s.

33. The method according to claim 1, wherein the step of producing a mixture by mixing the untreated saline water with an aqueous solution containing hydroxide ions comprises the step of:
producing the mixture by flow introduction of the untreated saline water into the aqueous solution containing hydroxide ions.

34. The method according to claim 33, wherein the step of producing the mixture by flow introduction of the untreated saline water into the aqueous solution containing hydroxide ions comprises the steps of:
charging a reaction vessel with the aqueous solution containing hydroxide ions; and
introducing the untreated saline water into the aqueous solution containing hydroxide ions via a substantially tangential flow.

35. The method according to claim 33, wherein the untreated saline water has an inflow velocity in the range from 0.1 m/s to 10 m/s.

36. The method according to claim 1, wherein the step of producing a mixture by mixing the untreated saline water with an aqueous solution containing hydroxide ions comprises the step of:
producing the mixture by flow introduction of the untreated saline water and by flow introduction of the aqueous solution containing hydroxide ions.

37. The method according to claim 36, wherein the step of producing the mixture by flow introduction of the untreated saline water and by flow introduction of the aqueous solution containing hydroxide ions comprises the steps of:
introducing the untreated saline water into a reaction vessel via a substantially tangential flow; and
introducing the aqueous solution containing hydroxide ions into the reaction vessel via a substantially tangential flow;

38. The method according to claim 36, wherein the untreated saline water has an inflow velocity in the range from 0.1 m/s to 10 m/s, and the aqueous solution containing hydroxide ions has an inflow velocity in the range from 0.1 m/s to 10 m/s.
